(19) United States
(12) Patent Application Publication
(10) Pub. No.: US 2011/0300272 A1
(43) Pub. Date: Dec. 8, 2011

(54) Microwave-Refrigerator Unit

(76) Inventor: Steven John Smario, Walnut Creek, CA (US)

(21) Appl. No.: 13/210,247

(22) Filed: Aug. 15, 2011

Related U.S. Application Data
(63) Continuation of application No. 11/904,729, filed on Sep. 28, 2007, now abandoned.

(51) Int. Cl. F25D 23/00; A23L 3/00; A47B 81/00; A23L 1/01

(52) U.S. Cl. 426/243; 312/100; 312/403

(57) ABSTRACT

Microwave-refrigerator units are disclosed. In one aspect, a microwave-refrigerator unit may include a weatherproof exterior. A microwave may be included within the weatherproof exterior. A refrigerator may also be included within the weatherproof exterior. The refrigerator may be coupled with the microwave. Other microwave-refrigerator units are also disclosed, as are methods of using microwave-refrigerator units.

### BACKGROUND

1. Field

Embodiments of the invention pertain to a microwave-refrigerator unit.

2. Background Information

Refrigerators and microwaves are appliances commonly found together in kitchens. Refrigerators have been around for decades. Microwaves have also been around for a number of years. Typically, the refrigerators and microwaves are implemented as separate appliances that are physically uncoupled.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of a weatherproof microwave-refrigerator unit, according to one or more embodiments of the invention.

FIG. 2 is a block diagram illustrating a first example configuration of a microwave-refrigerator unit, according to one or more embodiments of the invention.

FIG. 3 is a block diagram illustrating a second example configuration of a microwave-refrigerator unit, according to one or more embodiments of the invention.

FIG. 4 is a block diagram illustrating a third example configuration of a microwave-refrigerator unit, according to one or more embodiments of the invention.

FIG. 5 is a block diagram of a portable microwave-refrigerator unit, according to one or more embodiments of the invention.

FIG. 6 is a block diagram conceptually illustrating one example configuration for an interior of a refrigerator having various example portability features and features useful for a construction site, according to one or more embodiments of the invention.

FIG. 7 is a block flow diagram of a method of using unit having a microwave and a refrigerator, according to one or more embodiments of the invention.

FIG. 8 is a block diagram of a microwave-refrigerator unit having securing and locking features, according to one or more embodiments of the invention.

FIG. 9 is a block diagram of a front view of a microwave-refrigerator unit having one or more drawers coupled therewith, according to one or more embodiments of the invention.

FIG. 10 is a block diagram of a microwave-refrigerator unit according to a first example power configuration, according to one or more embodiments of the invention.

FIG. 11 is a block diagram of a microwave-refrigerator unit according to a second example power configuration, according to one or more embodiments of the invention.

FIG. 12 is a perspective view of one particular embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description.

### I. Introduction

Construction jobsites typically employ construction workers and other personnel. as used herein, the term “construction jobsite” is to be interpreted broadly to cover locations where construction is performed to build and/or repair houses, buildings, roads, bridges, parks, dams, or other structures or dwellings.

The personnel are typically given breaks (e.g., lunch breaks) during which they may eat and drink. Some personnel may bring items (e.g., sack lunches) for consumption at the construction jobsite. These personnel may stay at the construction jobsite and thereby avoid spending time traveling offsite. As a result, these personnel may tend to take shorter and/or more restful breaks. This may tend to result in an improvement in the amount and/or quality of work performed by these personnel.

Other personnel may desire to consume hot food (which may not be readily available without a microwave) and/or cold beverages (which may not be readily available without a refrigerator). However, the food storage and preparation capabilities of many construction sites are often quite limited. In particular, the construction jobsites typically lack the heating capability provided by microwaves and/or the cooling capability provided by refrigerators. This deficiency may tend to result in more personnel leaving the construction jobsites during their breaks. Some personnel may go to restaurants. Others may go home to prepare food in their kitchens. This travel offsite, wait time at restaurants, etc. may tend to result in the personnel taking longer and/or less restful breaks. This may tend to result in a decrease in the amount and/or quality of work performed by these personnel who leave the construction jobsite.

The inventor believes that a combined microwave-refrigerator unit adapted for use at a construction jobsite may offer the advantage of helping to keep construction workers and other personnel at the construction jobsite during breaks. This in turn may help to increase the amount and/or quality of work performed by these personnel. Accordingly, it is hoped and believed that the microwave-refrigerator units disclosed herein may greatly improve the food preparation capabilities at construction sites. It is also hoped and believed that these microwave-refrigerator units deployed at construction sites may quickly pay for themselves through improved amounts and/or quality of work performed by personnel utilizing the units.

While the microwave-refrigerator units disclosed herein may be found to be useful at construction jobsites, it is to be understood that the scope of the invention certainly is not limited to using these microwave-refrigerator units at construction jobsites. Rather, the microwave-refrigerator units disclosed herein, in any of their various forms, may also, or alternatively, be found to be useful on a patio of a residence, in an outside kitchen of a home, for tailgating at sporting events, on a deck of a boat, in a garage, in a dorm room, or at many other possible locations.

### II. Weatherproof Microwave-Refrigerator Unit

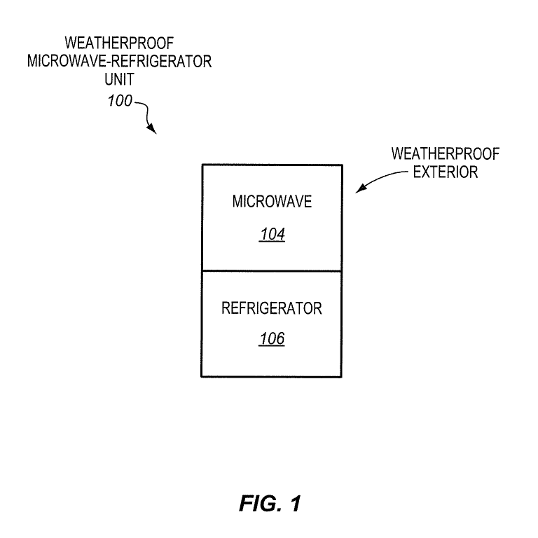

FIG. 1 is a block diagram of a weatherproof microwave-refrigerator unit 100, according to one or more embodiments of the invention. The weatherproof microwave-refrigerator unit has a weatherproof exterior 102. A microwave 104 is included within the weatherproof exterior. A refrigerator 106 is included within the weatherproof exterior and coupled with the microwave. In the illustration, the microwave is over the refrigerator, although this is not required.

The microwave, or microwave oven, may include a heating appliance that includes a compartment and a mechanism to heat food or other contents within the compartment by heat produced by the absorption of applied microwave radiation or energy. The refrigerator may include a cooling appliance that includes a generally thermally insulated compartment and a mechanism to transfer heat from the compartment to the external environment, thereby cooling food or other contents within the compartment to a temperature below ambient. Various different types of refrigerators and microwaves are well known in the art and are suitable. If desired, the refrigerator may optionally have a freezer compartment.

The refrigerator and microwave are coupled together. The terms “coupled” and “connected,” along with their derivatives, may be used herein. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. For example, the microwave and refrigerator may be coupled through one or more intervening coupled components.

It is believed that combining the refrigerator and the microwave together into the same unit provides a unit that is better than the sum of its individual parts (i.e., the microwave and refrigerator taken separately). When combined in the unit, the refrigerator and the microwave do not work separately or individually. Rather, the refrigerator and the microwave interact and/or cooperate with one another for the common purpose of food preparation convenience, speed, and/or functionality. It is believed that a level of synergism or cooperation is achieved that results in a level of enhanced food preparation convenience, speed, and/or functionality, which is greater than that provided by the refrigerator and microwaves taken separately.

The unit has the weatherproof exterior 102. As used herein, the term “weatherproof exterior” means an exterior that is more weatherproof than the exterior of a standard household microwave and/or refrigerator used in kitchens. In one or more embodiments of the invention, the weatherproof exterior may be sufficiently weatherproof that the unit may operate during prolonged periods of exposure, for example on the order of a month, a year, or more, when exposed to different extremes of weather, including rain, snow, wind, and the heat of the sun. In one or more embodiments, the microwave and the refrigerator may be sufficiently weatherproof that electrical systems are not shorted out and do not become dangerous even during heavy and prolonged rains.

In one or more embodiments, a back of the microwave and the refrigerator may have a weatherproof exterior. In one or more embodiments, an awning, visor, rim, brim, or like water shielding device may be arranged to help prevent rain water or other water from dripping or leaking into the microwave through the top of the door and/or through openings in the back. The water shielding device may redirect the water to drip over the edge of the microwave instead of into the unit through the door. The back of the refrigerator may have holes, slits, or other openings for ventilation useful for cooling. In one or more embodiments of the invention, the openings may each have an awning, visor, rim, brim, or like water shielding device to help prevent water from entering the opening. In one aspect, the back of the refrigerator may look somewhat like the working face of a cheese grater, although the scope of the invention is not so limited These water shielded openings may help to encourage water to flow over or around the openings, instead of into or through the openings. Such weatherproofing may be accomplished through seals, gaskets, etc.

In one or more embodiments of the invention, a majority of the weatherproof exterior of the unit may include, or be made of, a durable lightweight non-metal structural material, although this is not required. One example of a suitable durable lightweight non-metal structural material is plastic. Examples of suitable types of plastic include, but are not limited to, polyethyelene, polypropylene, polystyrene, polymethylmethacrylate, other types of plastics known in the art, combinations of such plastics, and combinations of such plastics with other materials (e.g., fiber reinforced plastics). The scope of the invention is not limited to any known type of plastic. The use of plastic, while not required, may help to reduce the weight, and generally also the cost, of the unit. Alternatively, a metal, such as, for example, steel, stainless steel, or aluminum, may optionally be used. In the case of steel, or certain other metals, paint or another coating may optionally be used to help prevent rust or otherwise provide weatherproofing.

Advantageously, the weatherproof microwave-refrigerator unit may be capable of reliable prolonged use outside while exposed to the weather. Standard microwaves and refrigerators used in kitchens generally are not designed to be sufficiently weatherproof. By way of example, such a weatherproof microwave-refrigerator unit may be advantageously employed at a construction jobsite, on a patio of a residence, in an outside kitchen of a home, for tailgating at sporting events, on a deck of a boat, or at other outside locations exposed to weather.

### III. Different Configurations of Weatherproof Microwave-Refrigerator Unit

Now, the weatherproof microwave-refrigerator units disclosed herein may be manufactured in different ways. Three example configurations will be discussed to further illustrate certain concepts.

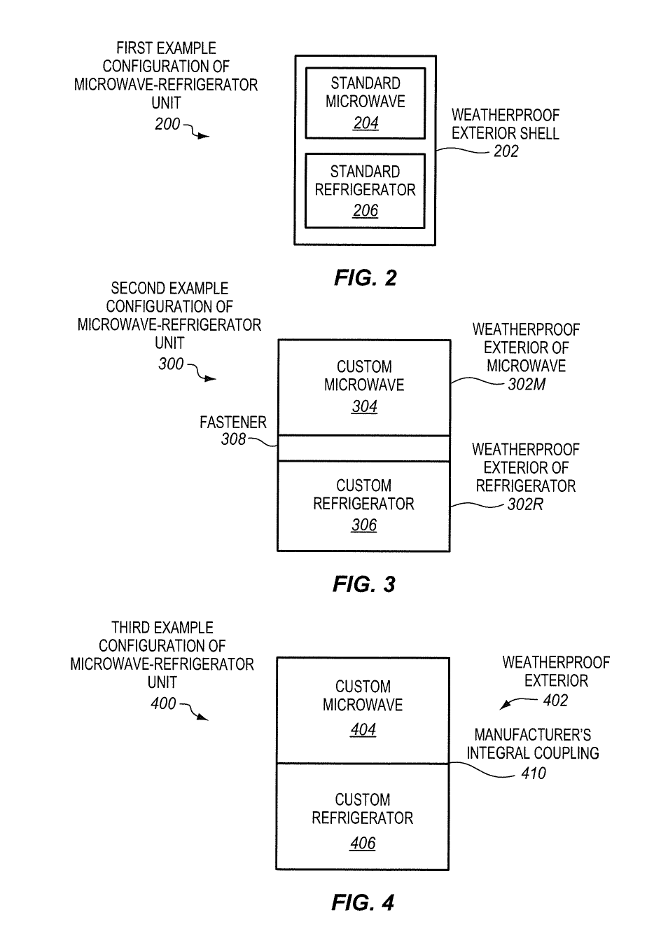

FIG. 2 is a block diagram illustrating a first example configuration of a microwave-refrigerator unit 200, according to one or more embodiments of the invention. This configuration includes a weatherproof exterior shell 202, a potentially standard off-the-shelf microwave 204 included within the weatherproof exterior shell, and a potentially standard off-the-shelf refrigerator 206 included within the weatherproof exterior shell. Alternatively, custom microwaves and refrigerators may optionally be used. In one or more embodiments, the weatherproof exterior shell may be a plastic or other shell designed specifically to tightly house, and provide weatherproofing to, the microwave and refrigerator. One potential advantage of this configuration is the ability to optionally use standard off-the-shelf microwaves and refrigerators without needing to change their design in order to make them weatherproof.

FIG. 3 is a block diagram illustrating a second example configuration of a microwave-refrigerator unit 300, according to one or more embodiments of the invention. This configuration includes a custom microwave 304 having a weatherproof microwave exterior 302M, a custom refrigerator 306 having a weatherproof refrigerator exterior 302R, and a fastener 308 disposed between the microwave and the refrigerator to fasten them together. Examples of suitable types of fasteners include, but are not limited to, rivots, screws, bolts, clamps, adhesives, welding, other fasteners known in the arts, and combinations thereof. One potential advantage of this second configuration is the ability to manufacture the microwave and refrigerator separately, for example in different processes, and then assemble them together to form the unit.

FIG. 4 is a block diagram illustrating a third example configuration of a microwave-refrigerator unit 400, according to one or more embodiments of the invention. In this configuration the unit is a custom integrally manufactured microwave-refrigerator unit. A microwave 404 and the refrigerator 406 are coupled together at a manufacturer's integral coupling 410. One potential advantage of this third configuration is the ability to manufacture an integrated, cohesive, or seamless unit without the need for separate assembly.

### IV. Portable Microwave-Refrigerator Unit

There would be certain advantages to a portable microwave-refrigerator unit having one or more portability features to allow it to be moved more readily from one location to another. By way of example, such a portable microwave-refrigerator unit may be advantageously moved between different construction sites or within a construction site, moved around a patio or outside kitchen of a residence, moved from a garage to an outside driveway or patio, moved from a home to a parking lot at a sporting event for tailgating, or moved between other desired locations.

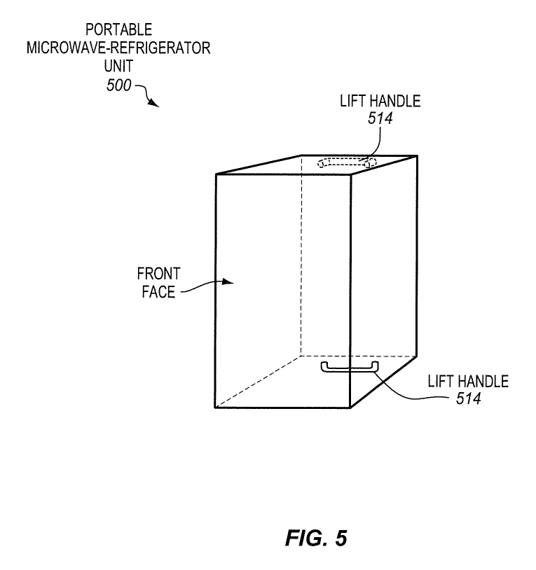

FIG. 5 is a block diagram of a portable microwave-refrigerator unit 500, according to one or more embodiments of the invention. The portable microwave-refrigerator unit has one or more portability features 514 coupled therewith.

Handles 514 are one suitable type of portability feature. As is known, a handle may include a part or structure that is designed especially to be grasped by the hand. Various sizes, shapes, and forms of handles are suitable.

The illustrated unit has two lift handles 514. The lift handles are coupled with the exterior on opposite ends of the unit to allow the unit to be lifted more easily. The topmost lift handle may be either on the top of the unit toward the back or on the back of the unit toward the top of the unit. The lowermost lift handle may be either on the bottom of the unit toward the back of the unit or the back of the unit toward the bottom. It is thought that this configuration of handles may facilitate ease of carrying the unit. No specific handles are required. Fixed bars or other parts or structures that can be readily grasped and held on to by the hand are suitable. In one aspect, the handles may be hinged so that they may lay flat against the surface of the unit and then hingably raised to carry the unit. In one aspect, the unit may be relatively light, such as, for example, around a hundred pounds or less.

Optionally, the unit may include one or more wheels (not shown). The wheels are another suitable type of portability feature. As is known, a wheel may include a circular frame of a material that may be solid, partly solid, or spoked, and that is capable of turning on an axle. By way of example, the unit may have two or four wheels. The wheels may be designed to lock in place or be removed or otherwise give the unit a solid stance when in place. Alternatively, the wheels may be omitted, since the unit may be relatively light and may instead simply be carried, for example, using the aforementioned handles. If desired, the unit may optionally include one or more push handles coupled with the exterior on one side of the unit to allow the unit to be pushed from that side and rolled on the wheels.

It is not required that the unit include all of these portability features. Additionally, these are just a few illustrative examples of suitable portability features. Other portability features may optionally be used instead of the illustrated portability features.

In one or more embodiments, the size and/or shape of the unit may be designed to facilitate portability and/or maneuverability potentially within a construction jobsite. For example, in one or more embodiments, the size of the unit may be in the range of about five to about six feet in height. In one or more embodiments, the width of the unit may be less than about thirty inches. Thirty inches is about the width of a common or standard door opening at a construction job site. In one or more other embodiments, the width of the unit may be less than about thirty-six inches. Thirty-six inches is about the standard or common width of the entry door of a home. In one or more other embodiments, the depth may be around twenty-eight to thirty-two inches. In one or more other embodiments, the weight may be on the order of about one-hundred pounds, or less. However, the scope of the invention is not limited to these particular sizes, shapes, or weights, which may be used in some embodiments, but may not be used in other embodiments.

### V. REFRIGERATOR INTERIOR HAVING PORTABILITY FEATURES AND FEATURES USEFUL FOR CONSTRUCTION SITE

The inside of the unit may also optionally include one or more portability features. In particular, the inside of the refrigerator may optionally include one or more portability features.

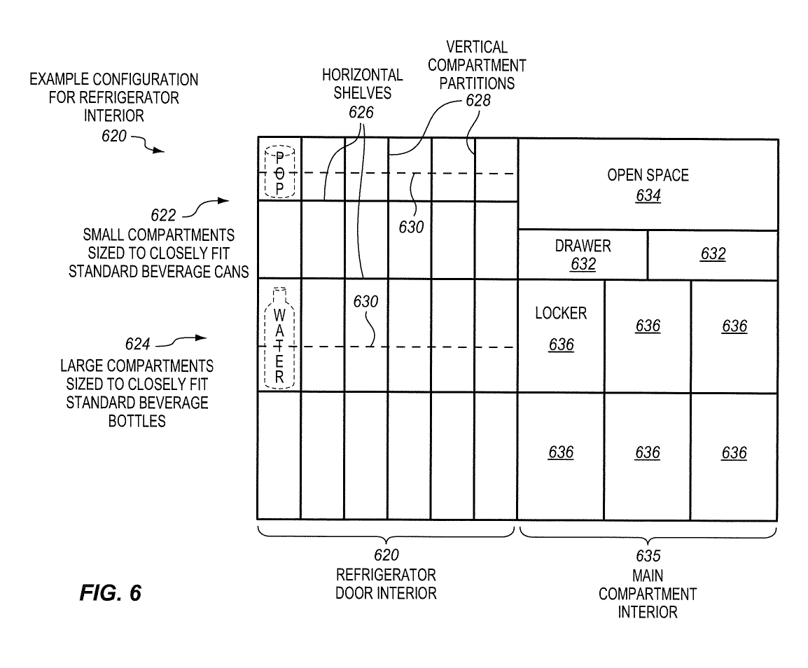

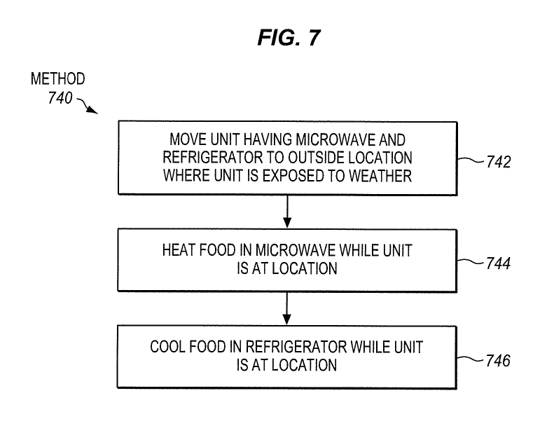

FIG. 6 is a block diagram conceptually illustrating one example configuration for a refrigerator interior 620 having various example portability features 622, 624, 630, 636 and features useful for a construction site 636, according to one or more embodiments of the invention. The portability features may help secure food items in place during movement of the microwave-refrigerator unit.

An example configuration for a refrigerator door interior 620 is shown at the left. As shown, the refrigerator door may include a plurality of small compartments 622 and a plurality of large compartments 624. These are examples of portability features. Small and large are intended as relative terms. Fewer or more compartments of either type may optionally be used. The compartments are formed in part by horizontal shelves 626 and vertical compartment partitions 628.

The compartments are each specifically sized to closely fit standard beverage containers. As one example, the small compartments may be sized to closely fit aluminum pop cans, whereas the large compartments may be sized to closely fit plastic bottles. The locations of an aluminum pop can and plastic water bottle are shown for purposes of illustration, although it is to be appreciated that they are not part of the invention. Such sized compartments may help to secure the standard beverage containers in place during movement of the unit.

As further shown, the refrigerator door may optionally include additional portability features 630 to retain the standard beverage containers in place during movement of the unit. Examples of suitable features include, but are not limited to, one or more bars, rubber cords, ropes, nets, biasing springs, and the like, and combinations thereof.

Turning now to the example configuration of the main compartment interior 635 shown at right. As shown, the main compartment interior may optionally include a plurality of lockers 636. Fewer or more lockers may optionally be included. In one or more embodiments of the invention, each of these lockers may have a hinged door. Such lockers may allow people to keep their respective food items separate. Accordingly, such lockers may offer certain potential advantages at a construction jobsite or other environment where different people not of the same family share the same microwave-refrigerator unit. In other implementations the lockers may optionally be omitted.

Optionally some or all of these lockers may have a locking mechanism, such as, for example, a lock or staple. As is known, a staple may include a metal loop, generally having a U-shape, and having two ends that are secured to a surface to hold the hook, hasp, or bolt of a lock. Such locking mechanisms may allow people to keep their respective food items secure or protected (e.g., from unintentional consumption or theft).

The main compartment also optionally includes a plurality of drawers 632. Fewer or more drawers may optionally be included. The main compartment also optionally has open space 634.

It is to be appreciated that this is just one illustrative example. Many modifications of the configurations of the interior are contemplated and will be apparent to those skilled in the art and having the benefit of the present disclosure.

### VI. Method of Using a Portable, Weatherproof Microwave-Refrigerator Unit

One or more embodiments of the invention pertain to a method involving moving a unit including a microwave and a refrigerator. FIG. 7 is a block flow diagram of a method 740 of using unit having a microwave and a refrigerator, according to one or more embodiments of the invention.

At block 742, a unit having a microwave and a refrigerator may be moved to an outside location where the unit is exposed to weather. In one or more embodiments of the invention, the unit may be moved to a construction jobsite, although the scope of the invention is not so limited. By way of example, moving the unit may include rolling the unit on one or more wheels, or carrying or pushing the unit with one or more handles, or both.

Then, food may be heated in the microwave while the unit is at the location, at block 744. Food may be cooled in the refrigerator while the unit is at the location, at block 746. The heating and cooling operations may be performed in any desired order, perhaps repeatedly, on potentially different food items, and potentially by different people. Furthermore, this method has been shown in a basic form, but operations may optionally be added to and/or removed from the method.

### VII. Microwave-Refrigerator Unit Having Securing and Locking Features

As explained elsewhere herein, construction jobsites are one possible location where a microwave-refrigerator unit as disclosed herein may be advantageously employed. Certain construction jobsites are often unoccupied at night. As such, microwave-refrigerator units employed at these construction jobsites may potentially be vulnerable to theft. Either the microwave-refrigerator unit itself may be stolen, or the contents within the refrigerator may be stolen, or both. Theft of the microwave-refrigerator unit itself may be an even bigger concern if the unit has wheels or handles or other portability features. Accordingly, in one or more embodiments of the invention, a microwave-refrigerator unit may include one or more security and/or locking features to help protect against theft. Such a microwave-refrigerator unit may be useful at construction jobsites and various other locations where theft may be a concern.

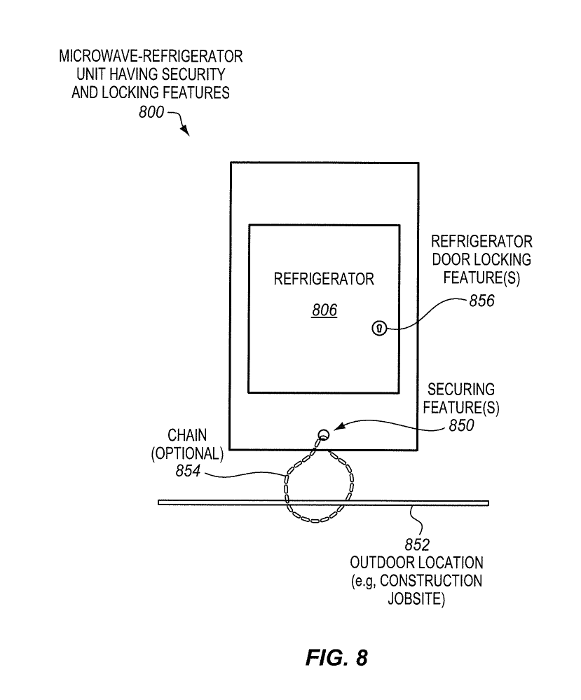

FIG. 8 is a block diagram of a microwave-refrigerator unit 800 having securing 850 and locking features 856, according to one or more embodiments of the invention.

As shown, one or more securing features 850 are coupled with the unit to allow the unit to be secured to a location 852, such as, for example, a construction jobsite. In one or more embodiments of the invention, the one or more securing features may include at least one hole drilled or otherwise formed through the exterior to pass one of a chain, a cable, and a rope. The chain, cable, or rope may be secured to a building, telephone pole, crane, stake in the ground, heavy object, or otherwise secured to the location. A chain 854 is shown in dashes to indicate it is not necessarily part of the invention.

As another option, in one or more embodiments of the invention, the one or more securing features may include a staple coupled with the weatherproof exterior. The staple may include a metal loop, potentially having a generally U-shape, and having two ends that are secured to a surface. A chain, cable, rope, lock, or the like, may be passed through the staple to secure the unit to the location. Other securing features are also contemplated.

As shown, the microwave-refrigerator unit may have one or more locking features 856 to lock a door of a refrigerator 806. In one or more embodiments of the invention, the one or more locking features may include a lock on the refrigerator door. By way of example, the lock may be opened with a key, a combination, or a code. Alternatively, in one or more embodiments, the one or more locking features may include one or more metal staples coupled with the refrigerator and its door.

In one or more embodiments, the unit may have one or more features or mechanisms to help prevent vandals from operating the microwave (for example after working hours) and potentially damaging the microwave and/or posing a safety concern. In one or more embodiments, the microwave may have one or more locking features and/or a power disable mechanism. Known locking devices are suitable. The power disable mechanism may disable or cut-off power to the microwave or turn off the power supply so that the microwave cannot be used. In one or more embodiments of the invention, a switch, button, lever, dial, knob, keypad, or other user activated means for activating the one or more locking features of the microwave and/or the power disable mechanism may be included within the interior of the refrigerator. In one aspect, a switch similar to those used to turn on and off a flashlight may optionally be used. That is, in one or more embodiments, a device or means for locking or disabling the microwave may be included within the interior of the refrigerator. When securing the unit, for example at the end of the workday, the one or more locking features of the microwave may be activated and/or the power disable mechanism may be disabled from within the interior of the refrigerator. Then, the refrigerator door may be locked as previously described. In one aspect, the device or means may be moisture resistant to prevent damage by condensation from the refrigerator.

### VIII. Microwave-Refrigerator Unit Having One or More Drawers

Certain locations where a microwave-refrigerator unit may be deployed may lack adequate storage and/or food preparation surface area. For example, storage and a clean food preparation surface near the unit may tend to be limited in certain construction sites, on certain patios, in certain parking lots at a tailgating party, and at other locations where the unit may be deployed. Additional un-refrigerated storage and/or surface area for food preparation are additional features that may advantageously be included in a microwave-refrigerator unit. In one or more embodiments of the invention, a microwave-refrigerator unit may have one or more retractable drawers to provide the storage or surface area for food preparation.

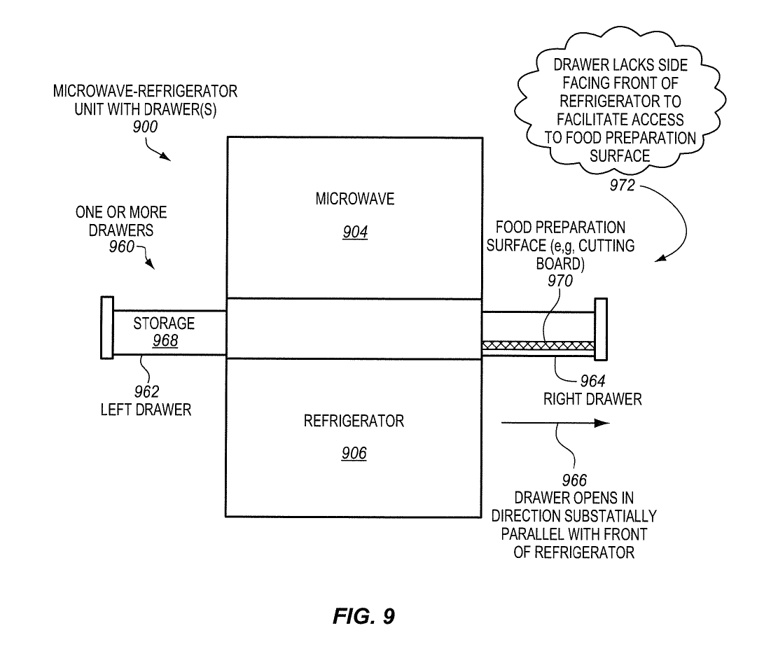

FIG. 9 is a block diagram of a front view of a microwave-refrigerator unit 900 having one or more drawers 960 coupled therewith, according to one or more embodiments of the invention. The illustrated unit has a left drawer 962 and a right drawer 964. Although in alternate embodiments, either fewer or more drawers may optionally be included.

As shown, the drawers may optionally be coupled between a refrigerator 906 and a microwave 904 of the unit, although this is not required. Providing the drawers between the refrigerator and the microwave generally tends to provide for improved access to the drawers, although this depends in part on the relative size of the refrigerator (or microwave if it is on the bottom). In one or more embodiments of the invention, the unit may be sized such that the drawers may be between hip and chest level for a representative or average person intended to use the unit, although this is not required.

The drawers may each include a sliding structure, such as a receptacle, compartment, drawer bottom, or tray, which may be opened by pulling it out, and closed by pushing it in. In this front view, the fronts of the microwave and refrigerator are visible. As shown, in one or more embodiments, the drawers may slid open in a direction 966 that is substantially parallel or aligned with the front of the refrigerator. While this is not required, this may help to prevent the drawers when open from blocking access to the microwave and/or the refrigerator. As used herein substantially parallel or substantially aligned means that they form an angle of less than 45°. As used herein, parallel or aligned means that the angle is less than 15°.

In one or more embodiments of the invention, the unit may include one or more drawers to provide un-refrigerated storage. In the illustration, the left drawer provides storage 968. By way of example, the storage may be used to store salt, pepper, condiments, napkins, silverware, knives, cleaning supplies, aluminum foil, or other items useful for food preparation. However, the scope of the invention is not limited to what contents are to be included in the drawer.

In one or more embodiments of the invention, the unit may include one or more drawers to provide a food preparation surface. In the illustration, the right drawer provides a food preparation surface 970. The food preparation surface is a top surface of the bottom of the drawer.

In one or more embodiments of the invention, the food preparation surface may include a cutting board. As used herein, a cutting board may include any wood, plastic, metal, stone, or other surface sufficiently durable to withstand the pressure and cutting action of routine cutting of food items with a knife.

As indicated at comment bubble 972, in one or more embodiments, a drawer may lack a side, for example a side facing the front of the refrigerator. Omitting this side of the drawer may help to provide improved access to the food preparation surface.

Storage may be provided toward the back of the drawer. By way of example, the storage may be used to store silverware, a knife, salt, pepper, condiments, a sponge or rag, or other items associated with food preparation. Alternatively, if such storage is not desired, the drawer may optionally be replaced with a retractable tray that provides the food preparation surface.

Providing the food preparation surface through a drawer may allow the food preparation surface to be retractable, which may be useful for portability and to reduce the size or footprint of the unit when the food preparation surface is not needed. This may also help to keep the food preparation surface clean, which may be advantageous when the unit is deployed at a construction jobsite or other outside location exposed to dust or dirt.

It is believed that combining the storage and/or the food preparation surface with the microwave-refrigerator unit provides a unit that is better than the sum of its individual parts (i.e., the storage and/or surface and the microwave-refrigerator unit taken separately). When combined in the unit, storage and/or the food preparation surface may be used interactively or cooperatively with the microwave-refrigerator unit for the common purpose of food preparation convenience, speed, and/or functionality. It is believed that a level of synergism or cooperation is achieved that results in a level of enhanced food preparation convenience, speed, and/or functionality, which is greater than that provided by the storage and/or surface and the microwave-refrigerator unit taken separately.

### IX. Different Power Supply Configurations

In one or more embodiments of the invention, a microwave-refrigerator unit as disclosed herein may derive electrical power for both the microwave and refrigerator through a single common power cord coupled with the unit. Two example configurations will be discussed to further illustrate certain concepts. These figures also illustrate different ways in which power to the microwave may be disabled from within the interior of the refrigerator, such as, for example, for security or safety, as previously described.

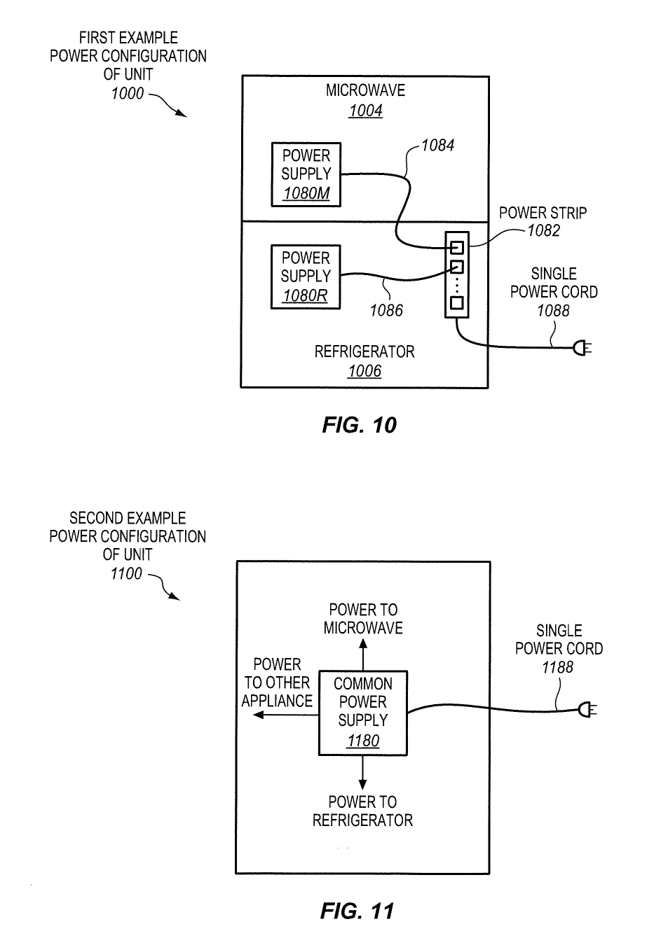

FIG. 10 is a block diagram of a microwave-refrigerator unit 1000 according to a first example power configuration, according to one or more embodiments of the invention. This first power configuration may be useful for the configuration shown in FIG. 2, as well as other configurations.

The unit includes a microwave 1004 and a refrigerator 1006. The microwave has a microwave power supply 1080M. The refrigerator has a refrigerator power supply 1080R. The power supplies may each include a device to supply electrical energy to one or more output loads. The power supply may perform conversion of an input form of electrical power to an output form and voltage. For example, the power supply may convert from 120 or 240 volt AC supplied by a utility company to a well-regulated lower voltage DC.

The unit includes a power strip 1082. The power strip may include an electrical device including a cord with a plug on one end and several outlets on another end. Commercially available power strips are suitable.

A power cord 1084 of the microwave may be plugged into, or otherwise coupled with, a first outlet of the power strip. A power cord 1086 of the refrigerator may be plugged into, or otherwise coupled with, a second outlet of the power strip. The power strip may have one or more remaining outlets to allow one or more other electronic devices to be coupled to receive power from the unit.

The power strip has a single power cord 1088 that may be plugged into an external outlet, or other source of power. The power strip may be included within a housing of the refrigerator, within a housing of the microwave, within a weatherproof exterior shell, or at another suitable location. In one aspect, the microwave and refrigerator power cords may be fully internal to the unit. Accordingly, from the outside a single power cord may be coupled with the unit.

During operation, both the refrigerator and the microwave may derive power through the single power cord of the power strip. The power strip may provide power to the respective power supplies through the respective power cords coupled with the respective power strip outlets.

FIG. 11 is a block diagram of a microwave-refrigerator unit 1100 according to a second example power configuration, according to one or more embodiments of the invention. This second power configuration may be useful for the configuration shown in FIG. 4, as well as other configurations.

The unit includes a common power supply 1180. A single power cord 1188 is coupled with the common power supply. The single power cord may be plugged into an external outlet or other source of power. Power may be provided to the common power supply through the single power cord.

The common power supply may provide power to both a microwave and a refrigerator of the unit. As shown, the common power supply may optionally provide power to other appliances or outlets of the unit.

In one or more embodiments of the invention, one or more other appliances may be coupled with the microwave-refrigerator unit. Examples of suitable components include, but are not limited to, a radio, a television, a coffee maker, a hot plate, or the like. In one aspect, the appliances may be plugged into an outlet of the unit such that they may readily be detached. In another aspect, the appliances may be formed more integrally with the unit.

### X. Detailed Example of Microwave-Refrigerator Unit

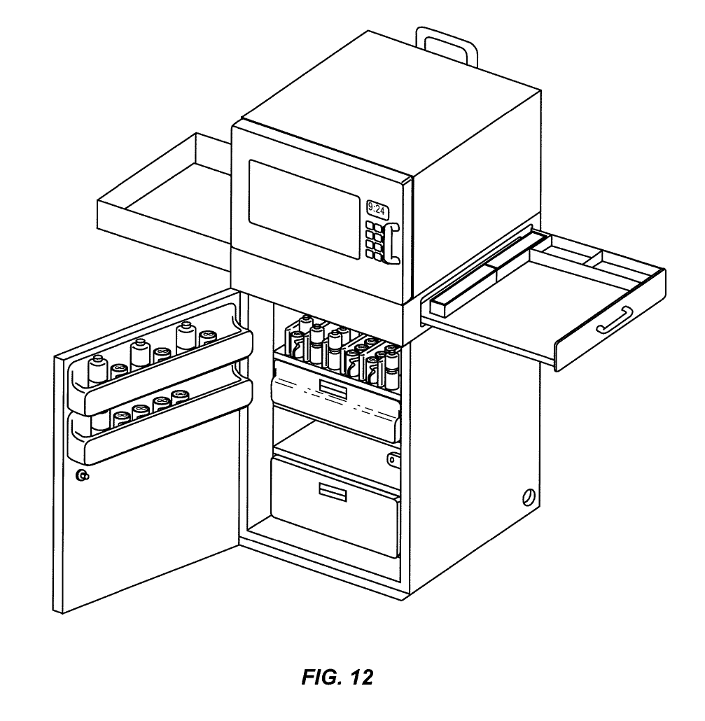

For purposes of illustration, in some instances, certain features have been combined within the same unit, although it is to be appreciated that these features may instead optionally be used separately. In other instances, certain features have been shown separately in the figures, although it is to be appreciated that these features may instead optionally be combined within the same unit. For example, a unit may have most or all of the features disclosed herein combined within the same unit. By way of example, FIG. 12 is a perspective view of one particular embodiment of the invention.

### XI. Other Matters

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

It will also be appreciated, by one skilled in the art, that modifications may be made to the embodiments disclosed herein, such as, for example, to the sizes, shapes, configurations, forms, functions, materials, and manner of operation, and assembly and use, of the components of the embodiments. All equivalent relationships to those illustrated in the drawings and described in the specification are encompassed within embodiments of the invention.

For simplicity and clarity of illustration, elements illustrated in the figures have not necessarily been drawn to scale. For example, the dimensions of some of the elements are exaggerated relative to other elements for clarity. Further, where considered appropriate, reference numerals or terminal portions of reference numerals have been repeated among the figures to indicate corresponding or analogous elements, which may optionally have similar characteristics.

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

1. An microwave-refrigerator unit adapted for outside use, to be portability, and to provide security, the microwave-refrigerator unit comprising:
a weatherproof exterior;
a microwave included within the weatherproof exterior;
a refrigerator included within the weatherproof exterior and coupled with the microwave;
one or more drawers coupled between the microwave and the refrigerator;
one or more portability features coupled with the apparatus;
one or more securing features coupled with the apparatus to allow the apparatus to be secured to a location; and
one or more locking features to lock a door of the refrigerator.

2. A method comprising:
moving the apparatus of claim 1 to a construction jobsite;
heating food in the microwave; and
cooling food in the refrigerator.

3. An apparatus comprising:
a weatherproof exterior;
a microwave included within the weatherproof exterior; and
a refrigerator included within the weatherproof exterior and coupled with the microwave.

4. The apparatus of claim 3, wherein a majority of the weatherproof exterior comprises a durable lightweight non-metal structural material.

5. The apparatus of claim 4, wherein the material comprises plastic.

6. The apparatus of claim 3, wherein the weatherproof exterior comprises at least one of a water shielding device over a door of the microwave and a water shielding device over an opening on a back of the unit.

7. The apparatus of claim 3, further comprising a device within an interior of the refrigerator that is operable to at least one of lock the microwave and disable the microwave.

8. The apparatus of claim 3, further comprising one or more portability features coupled with the apparatus.

9. The apparatus of claim 8, wherein the one or more portability features comprise one or more of:
one or more wheels coupled with the exterior;
one or more handles coupled with the exterior; and
a plurality of compartments within an interior of the refrigerator that are specifically sized to closely fit standard beverage containers to secure the standard beverage containers in place during movement of the apparatus.

10. The apparatus of claim 3, further comprising one or more drawers coupled with the apparatus.

11. The apparatus of claim 10, wherein the drawers comprise a drawer coupled between the refrigerator and the microwave.

12. The apparatus of claim 10, wherein the drawers comprise a drawer to open in a direction substantially parallel with a front of the refrigerator.

13. The apparatus of claim 10, wherein the drawer lacks a side to facilitate access to a food preparation surface on a bottom of the drawer.

14. The apparatus of claim 3, further comprising one or more securing features coupled with the apparatus to allow the apparatus to be secured to a location.

15. The apparatus of claim 14, wherein the one or more securing features comprise at least one of a metal staple coupled with the weatherproof exterior and at least one hole through the weatherproof exterior to pass one of a chain, a cable, and a rope.

16. The apparatus of claim 3, further comprising one or more locking features to lock a door of the refrigerator.

17. The apparatus of claim 16, wherein the locking features comprise at least one of a lock and at least one metal staple.

18. The apparatus of claim 3, further comprising a single power cord coupled with the apparatus.

19. The apparatus of claim 3, further comprising one or more outlets of the apparatus to allow one or more other electronic devices to receive power from the apparatus.

20. A method comprising:
moving the apparatus of claim 3 to a construction jobsite;
heating food in the microwave at the construction jobsite; and
cooling food in the refrigerator at the construction jobsite.

21-25. (canceled)
